(19) United States
(12) Patent Application Publication
(10) Pub. No.: US 2014/0250232 A1
(43) Pub. Date: Sep. 4, 2014

(54) DISASTER RECOVERY FAILOVER IN CLOUD COMPUTING

(71) Applicant: NATIONAL ICT AUSTRALIA LIMITED, Eveleigh, New South Wales (AU)

(72) Inventors: Anna Liu, Eveleigh, NSW (AU); Kevin Lee, Eveleigh, NSW (AU); Jorke Odolphi, Eveleigh, NSW (AU); Hiroshi Wada, Eveleigh, NSW (AU)

(73) Assignee: National ICT Australia Limited, Eveleigh, NSW (AU)

(21) Appl. No.: 14/349,621

(22) PCT Filed: Oct. 15, 2012
(86) PCT No.: PCT/AU2012/001245

§ 371 Date: Apr. 3, 2014

(30) Foreign Application Priority Data
Oct. 14, 2011 (AU) 2011904266

(51) Int. Cl. H04L 12/24

(52) U.S. Cl. CPC H04L 41/0896
USPC 709/226

(57) ABSTRACT

This disclosure relates to creating a resource and for configuring a resource (314) in cloud computing. A processor receives a source resource identifier of a source resource (304) in a source cloud (302) and sends a request to create a target resource (314) in the target cloud (312). The processor then receives a target resource identifier of the created target resource (314) and stores an association (500) between the target resource identifier (504) and the source resource identifier (502). Using the stored association allows to determine a target resource identifier for a resource identifier and therefore configuration of target resources, where the configuration depends on target resource identifiers.

### CROSS-REFERENCE TO RELATED APPLICATIONS

The present application claims priority from Australian Provisional Patent Application No 2011904266 filed on 14 Oct. 2011, the content of which is incorporated herein by reference.

### TECHNICAL FIELD

This disclosure generally relates to replicating resources in a cloud computing environment. In particular, but not limited to, it relates to a methods, systems and software for creating a resource and for configuring a resource.

### BACKGROUND ART

Cloud computing has changed many workflows related to the Internet. The differences between traditional server-based web hosting and web-services in the cloud will, now be described with reference to a simple example.

FIG. 1 illustrates a server-based web-hosting system 100 comprising a server 102 connected to a display 104, an input device 106, such as a keyboard, and a computer network 108, such as the Internet comprising a domain name service (DNS) server 109. A computer 110 of a user 111 is connected to the Internet 108.

Stored on the server 102 there is a computer file 112 comprising computer code, such as html, that characterises the content, appearance and behaviour of a webpage. Typically, the server 102 stores more than one such computer file but only one is shown for the sake of clarity. The server 102 executes a text editor software 114, such as Vim, and a webserver software 116, such as Apache. Both the text editor and the webserver access the computer file 112.

When in use, the display 104 shows the text editor 114 to a web designer 120. The web designer 120 uses the input device 106 to alter the computer file 112 to create or modify the content, appearance and behaviour of the web page. The web designer also registers an internet address, such as www.example.com, with the DNS server 109 such that the internet address is associated with the IP address of the server 102.

When the user 111 enters the internet address into a browser software executed on computer 110, the browser software queries the DNS server for the IP address related to the address. Then the browser software connects to the server 102 and retrieves the computer file 112. The browser software interprets the computer code of the computer file and displays the web page to the user 111.

Typically, many users access the webpage stored on server 102. The computer file may include complex instructions for processes executed on the server 102 such as an online shop. These processes require computing power and the required computation power depends on the number of users that access the computer file 112. It is difficult for the web designer to decide how much investment into computing power is necessary to provide reliable web presence.

FIG. 2 illustrates a cloud-based web hosting system 200 comprising a client computer 202 connected to the display 104, input device 106 and a cloud 208. A cloud is a distributed computer network where a web-designer 120 can use a flexible number of resources, such as computing instances, virtual machines, or disk volumes. Typically, the web-designer is charged by the time the web-designer 120 uses a computing instance or by the amount of data that is stored on a data volume.

The computer 110 of the user 111 is also connected to the cloud 208. Unlike in the example of FIG. 1, the client computer 202 executes only a browser 114. The computer file 112 is now stored in the cloud 208. The text editor 114 as well as the webserver software 116 are executed by the cloud 208.

When a user accesses the web page of web designer 120, the browser executed on computer 110 does not connect to the client computer 202. Instead, the computer 111 retrieves the computer file 112 from the cloud 208. The cloud 208 offers resources to a large number of providers such as web designer 120. These resources may be infrastructure, such as virtual servers with root access or virtual machines, which is referred to as Infrastructure as a Service (IaaS).

Reliability is a major concern for many cloud-based web hosting systems 200. To ensure high reliability, the cloud-based web hosting system 200 must be replicated such that the replica can be used instead of the original in case the cloud-based web hosting system is rendered inoperative by a major disaster, such as an earthquake. However, it is difficult to create a replica that offers identical functionality to the original web hosting system 200.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present invention as it existed before the priority date of each claim of this application.

### DISCLOSURE OF INVENTION

In a first aspect there is provided a method for creating a resource in a target cloud, the method comprising:
receiving or accessing a source resource identifier of a source resource in a source cloud;
sending a request to create a target resource in the target cloud;
receiving or accessing a target resource identifier of the created target resource; and
storing an association between the target resource identifier and the source resource identifier.

It is an advantage that an association between the target resource identifier and the source resource identifier is stored. The association is a useful product that allows the determination of a target resource identifier for a resource identifier and therefore configuration of target resources, where the configuration depends on target resource identifiers.

The source cloud may be located remotely from the target cloud.

The method may be repeated for two or more source resources such that two or more associations between target resource identifiers and source resource identifiers are stored.

The method may be repeated for two or more source resources in a sequence based on the type of the source resources.

The method may comprise determining a dependency between the two or more source resources and wherein the method is repeated for two or more source resources in a sequence based on the dependency between the two or more source resources.

Determining the dependency may be based on configurations of the two or more source resources.

The method may further comprise:
receiving or accessing a source configuration of the source resource, the source configuration comprising one or more configuration source resource identifiers;
determining for each configuration source resource identifier a configuration target resource identifier based on the stored association; and
sending a request to configure the target resource based on the determined configuration target resource identifiers.

It is an advantage that the request to configure the target resource is based on the determined configuration target resource identifiers. That way, the configured target resource is a replica of the source resource, which means that the target resource has identical functionality as the source resource and can be used instead of the source resource as a backup.

The target resource may be a computing instance.

The method may further comprise the step of determining an image for the target resource.

It is an advantage that a target resource can be instantiated with a particular image even in cases where the target cloud does not provide an image with the same identifier as the image chosen for the source resource.

Determining the image may comprise selecting one of multiple images.

Each of the multiple images may be associated with an image provider and selecting one of multiple images may be based on a reliability measure of each image provider.

Sending a request to create the target resource may comprise:
determining a target security group based on previously stored target security groups; and
sending to the target cloud a request to associate the created target resource with the determined target security group.

It is an advantage that the association of instances to security groups that is present in the source cloud is replicated in the target cloud such that the same level of security is achieved in the target cloud.

In a second aspect there is provided software, that when installed on a computer causes the computer to perform the method of any one or more of the preceding claims.

In a third aspect there is provided a computer system for creating a resource in a target cloud, the computer system comprising:
a data port to receive or access a source resource identifier of a source resource in a source cloud, to send a request to create a target resource in the target cloud, and to receive or access a target resource identifier of the created target resource; and
a processor to store in a data store an association between the target resource identifier and the source resource identifier.

In a fourth aspect there is provided a computer-implemented method for configuring a target resource in a target cloud, wherein one or more associations between one or more target resource identifiers and one or more source resource identifiers are stored in a data store, the method comprising:
receiving or accessing a source configuration of a source, resource, the source configuration comprising one or more configuration source resource identifiers;
determining for each configuration source resource identifier a configuration target resource identifier based on the one or more stored associations; and
sending a request to configure the target resource based on the determined configuration target resource identifiers.

The one or more associations may be stored in a sequence based on the type of the target resources.

The one or more associations may be stored in a sequence based on a dependency between source resources associated with the one or more source resource identifiers.

The determined configuration target resource identifier may be an identifier of a storage volume in the target cloud and sending a request to configure the target resource may comprise sending a request to attach the storage volume in the target cloud to the target resource.

The configuration source resource identifiers and the configuration target resource identifiers may be IP addresses.

Sending the request to configure the target resource may comprise sending a request to translate between the IP address of the target resource and the IP address of the source resource.

In a fifth aspect there is provided software, that when installed on a computer causes the computer to perform the method of the fourth aspect.

In a sixth aspect there is provided a computer system for configuring a target resource in a target cloud, the system comprising:
a processor to store in a data store one or more associations between one or more target resource identifiers and one or more source resource identifiers;
a data port to receive a source configuration of a source resource, the source configuration comprising one or more configuration source resource identifiers;
a processor to determine for each configuration source resource identifier a configuration target resource identifier based on the one or more stored associations; and
a data port to send a request to configure the target resource based on the determined configuration target resource identifiers.

In a seventh aspect there is provided a computer-implemented method for determining a target resource identifier of a target resource in a target cloud, the method comprising:
receiving or accessing a source resource identifier;
receiving or accessing one or more associations between one or more target resource identifiers and one or more source resource identifiers; and
determining a target resource identifier based on the source resource identifier and the one or more associations.

In an eighth aspect there is provided software, that when installed on a computer causes the computer to perform the method of the seventh aspect.

In a ninth aspect there is provided a computer-system for determining a target resource identifier of a target resource in a target cloud, the computer system comprising:
a data port to receive or access a source resource identifier;
a data store to store one or more associations between one or more target resource identifiers and one or more source resource identifiers; and
a processor to determine a target resource identifier based on the source resource identifier and the one or more associations and to store the target resource identifier in a data store.

Optional features described of any aspect, where appropriate, similarly apply to the other aspects also described here.

### BRIEF DESCRIPTION OF DRAWINGS

FIG. 1 illustrates a server-based web-hosting system.

FIG. 2 illustrates a cloud-based web hosting system.

Examples will be Described with Reference to the Following Figures in which:

FIG. 3 illustrates a computer network.

FIG. 4 illustrates a method 400 for creating a resource in a target cloud.

FIG. 5 illustrates a database storing associations between source resource identifiers and target resource identifiers.

FIG. 6 illustrates a configuration of a source resource.

FIG. 7 illustrates a configuration of a target resource.

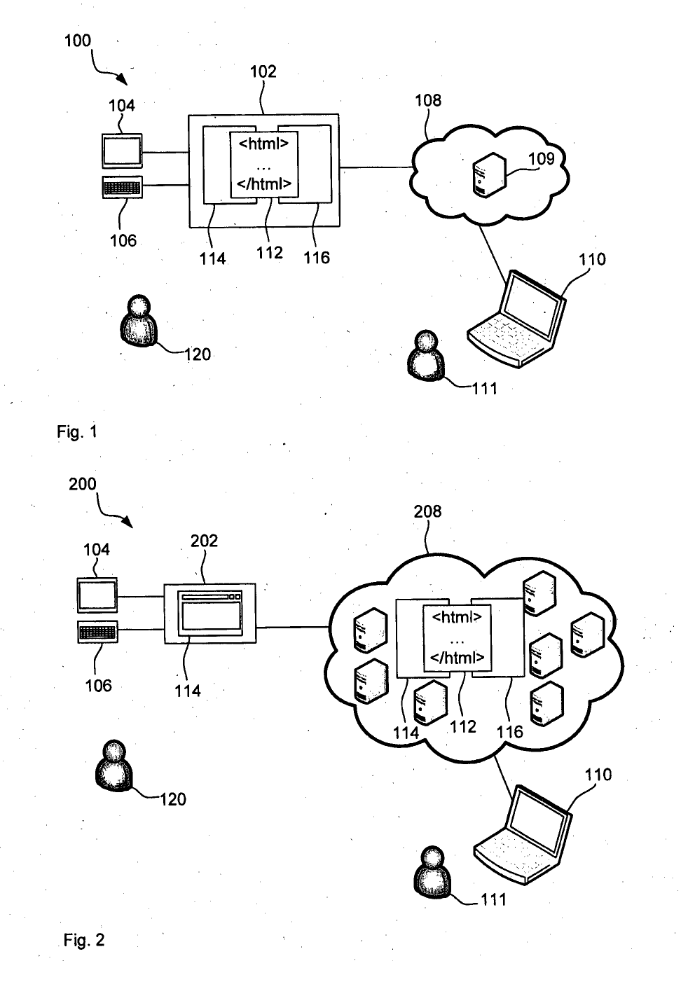

### BEST MODE FOR CARRYING OUT THE INVENTION

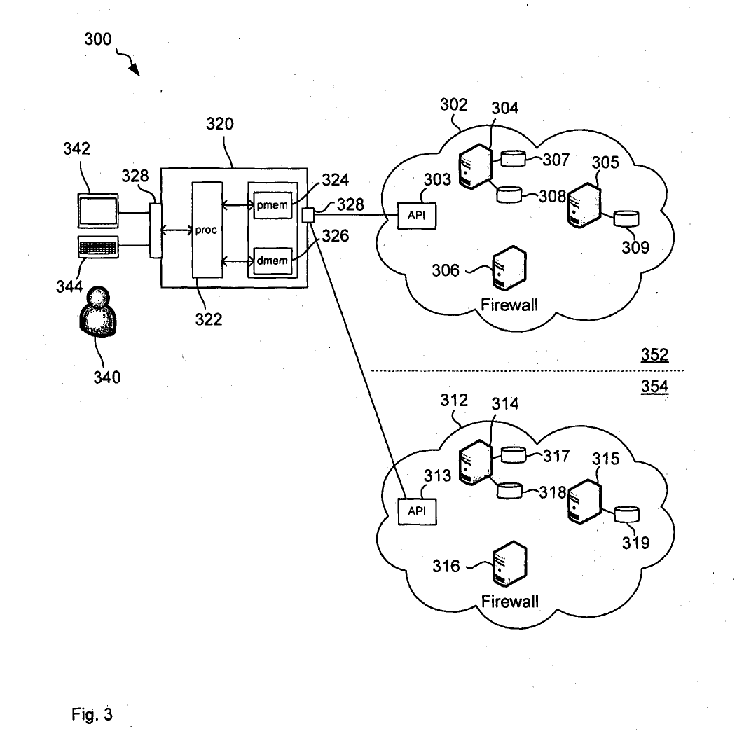

FIG. 3 illustrates a computer network 300 comprising a source cloud 302, comprising application programming interface (API) 303 and source resources 304 to 309, and a target cloud 312, also comprising an API 313 and target resources 314 to 319, connected to a controller 320, via a data communication network, such as the Internet (not shown). In this example, the controller 320 is separate or remote from the source cloud 302 and the target cloud 312. In other examples, the controller 320 may be implemented within the source cloud 302 or the target cloud 312, that is, a computing instance accesses program code that is stored on a storage volume in that cloud to perform the steps described below.

In order to achieve a greater reliability in case of great disasters, the functionality of the source cloud 302 is replicated in the target cloud 312. This replication is performed by controller 320 as will be described below.

Controller 320 comprises processor 322 connected to program memory 324 and data memory 326. Program memory 324 and data memory 326 may be located within the same physical data store, such as a RAM or hard-disk, or may be on separate data stores.. Controller 320 further comprises a network data port 328 to send and receive data from the source cloud 302 and the target cloud 312. The network data port 328 is to be understood as any physical or logical port that can receive or send information. Network data port 328 may be a network interface, such as a LAN or WLAN interface, a processor connection pin, a USB or firewire connection, a statement in executable computer code to call an API function, or an IP socket of a web service. Of course, network data port 328 may have separate ports for the source cloud 302 and the target cloud 310 or just one single port.

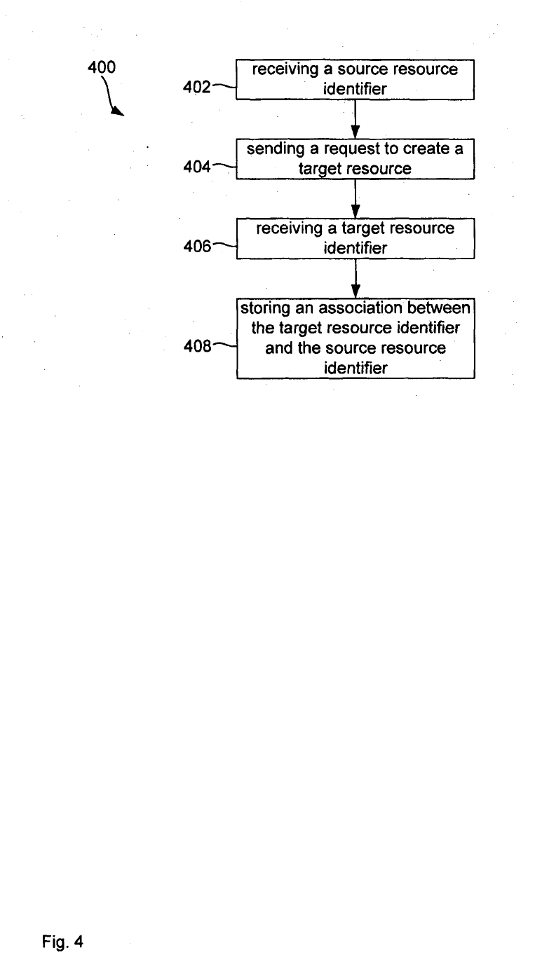

Controller 320 further comprises a user interface port 328 that allows processor 322 to display a graphical user interface on a screen 342 and receive control inputs via a user input device 344 from an administrator 340. When in use, the processor 322 executes software stored on program memory 324 to perform the method of FIG. 4, that is, the processor sends and receives data from the source API 303 and the target API 313 to create a resource in a target cloud 312. In one example, the processor 322 creates a replica in the target cloud 310 for each resource in the source cloud.

Source cloud 302 and target cloud 312 are located in different regions 352 and 354, respectively, remote from one another. In one example, source cloud 302 is located in the United States of America while target cloud 312 is located in Singapore. In this example, both the source cloud 320 and the target cloud 312 are Amazon Elastic Compute Cloud (Amazon EC2). A detailed description of the features of Amazon EC2 can be found on the Amazon website at http://aws.amazon.com/ec2/.

In this example, source resources 304 and 305 are computing instances, such as virtual machines or root access servers, source resource 306 is a firewall, source resources 307 and 308 are storage volumes attached to computing instance 304 and source resource 309 is a storage volume attached to computing instance 305.

For sake of clarity, firewall resource 306 is depicted as a virtual machine specialized to operate as a firewall. In many cases, however, the cloud provides firewall functionality, such as a set of access control lists called security groups in AWS, without the need for an instance that runs the firewall. In such cases, the firewall is a resource that can be configured by sending a request to the target cloud 312 as explained later.

In this example, storage volumes 307 and 309 are system storage volumes to store a kernel, operating system and other system-relevant information and software, such as program code implementing an online store. Storage volume 308 stores application data, such as warehouse management data or customer data. Of course, a different number of source resources with a different configuration of attached volumes is also possible and within the scope of the invention.

Target resources 314 to 319 of the target cloud 312 correspond to the source resources 304 to 309 in the source cloud as indicated by the last numeral of the reference number. It is noted that the target cloud 312 with target resources 314 to 319 is the final outcome or product after the processor 322 has performed the method in FIG. 4.

In this example, the API 313 of the target cloud 312 allows the creation of new resources but does not provide an option to set the identifiers of the newly created instances. However, the connectivity between instances in the source cloud 302 is based on identifiers of the source resources 304 to 309 and as a result, the connectivity will not be preserved by simply creating corresponding resources and copying the configuration data from the source cloud 302 to the target cloud 312.

FIG. 4 illustrates a method 400 for creating a resource in a target cloud. The method is explained here in the example of replicating source resource 304 into the target cloud 312. Of course, the method can be used to replicate different resources of different resource types, such as computing instances and storage volumes. The method 400 commences by processor 322 receiving or accessing 402 a source resource identifier of a source resource 304 in the source cloud 302. An example of a source resource identifier is the source resource identifier “i-d21fa486” of source resource 304.

In one example, the processor 322 receives the source resource identifier from the source cloud 302 via the API 303 of the source cloud 302. In a different example, the source resource identifier is stored on data memory 326, such as in a list of source resource identifiers, and the processor 322 accesses the source resource identifier from the data memory 326. In this case, the processor 322 comprises a further data port, such as a memory interface, to access the source resource identifier stored on the data memory 326. Of course, the processor 322 may access the source resource identifier from a storage volume within the source cloud 302 or the target cloud 312.

The processor 322 then sends 404 via data port 328 a request to create a target resource 314 in the target cloud 312 to the API 313 of the target cloud 312. In one example, where the controller 320 is separate from the target cloud 312, the processor 322 sends the request via the Internet to the target cloud 312. In another example, where the controller 320 is implemented by a computing instance within the target cloud 312, the computing instance sends the request within the target cloud 312 to the API, such as via a virtual IP network. The controller and the API may even reside in the same virtual machine and the request may be sent via a middleware layer, inter-process communication or calling a creation function of the API.

The API 313 of the target cloud 312 receives the request and creates a new instance and assigns a new identifier with the newly created instance 314, such as “i-6a28a52c”. As mentioned earlier, the API 313 assigns resource identifier randomly and does not allow changing the identifier. Therefore, the identifier of the newly created instance 314 will most likely be different to the source resource identifier that the processor 322 has received or accessed earlier.

The next step of method 400 is receiving 406 a target resource identifier of the created target resource, such as “i-6a28a52c”. It is noted that apart from the prefix indicating the resource type, the identifiers are entirely random and therefore, it is not possible to determine the target resource identifier from a given source resource identifier. Next, the method stores 408 an association between the target resource identifier (“i-6a28a52c”) and the source resource identifier (“i-d21fa486”).

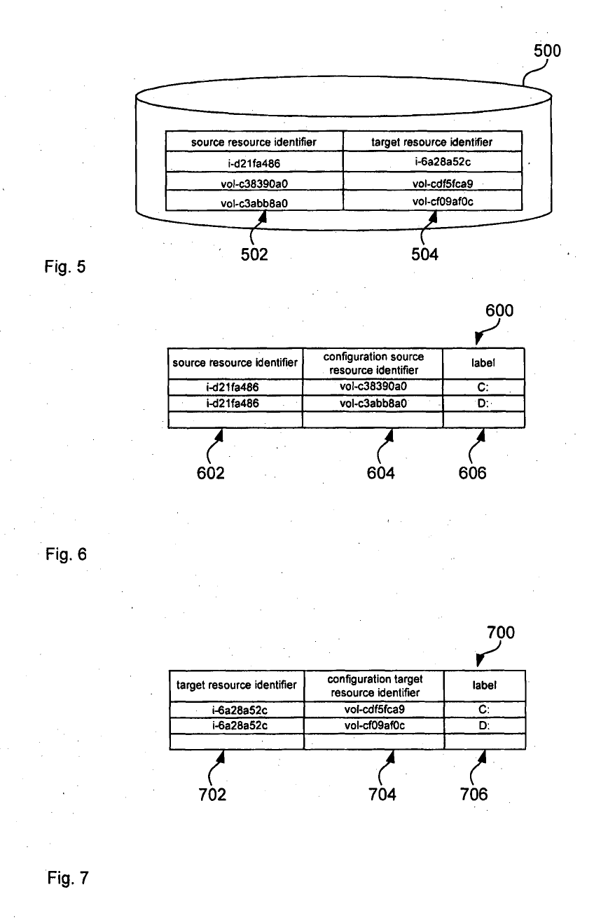

FIG. 5 illustrates a database 500 storing associations between source resource identifiers 502 and target resource identifiers 504. The database may be an SQL database stored on a data store, such as data memory 326. The database 500 comprises multiple records and each record comprises a field for a source resource identifier 502 and one field for a target resource identifier 504. An association between a source resource identifier and a target resource identifier is stored by creating a record in the database 500 with that source resource identifier and that target resource identifier. An association stored in database 500 indicates that the target resource is created as a replica of the source resource with the associated identifier.

In this example, volumes 307 “vol-c38390a0” and 308 “vol-c3abb8a0” as well as computing instance 304 “i-d21fa486” have been replicated by processor 322 meaning corresponding resources have been created in the target cloud 302.

The processor 322 can query the database, for example, to determine which target resource is associated with a given source resource, which means that the determined target resource has been created to constitute a replica of the source resource.

FIG. 6 illustrates a configuration 600 of source resource 304. In this example, source resource 304 is a computing instance and two storage volumes 307 and 308 are attached to the instance 304. Configuration 600 is a suitable data structure, such as a database with a first field for a source resource identifier 602 and a second field for configuration source resource identifier 604 and a field for a label 606 of the attached source resource. Of course, the database may comprise more fields for further meta-data of the storage volumes, such as size of the storage volume. It is noted here that configuration 600 may store the configuration of multiple, or even all source resources or alternatively, multiple configurations may exist, such as one configuration for each source resource.

The first row of configuration database 600 indicates that instance 304 “i-d21fa486” has attached volume 307 “vol-c38390a0” as a storage volume mounted under the label “C:”. In a similar manner, instance 304 “i-d21fa486” has attached a second volume 308 “vol-c3abb8a0” with label “D:”. That is, the configuration 600 of source resource 304 comprises one or more configuration source resource identifiers 604.

The method 400 of FIG. 4 may be continued by configuring the created target resource 314 such that the functionality of target resource 314 is identical to the functionality source resource 304 and therefore, target resource 314 is a replica of the source resource 304. In order to determine a configuration for target resource 314, the processor 322 accesses a source configuration 500 of the source resource from data store 326 or receives the source configuration 500 via port 328. As explained earlier, the source configuration 500 comprises one or more configuration source resource identifiers 604. The processor 322 determines for each configuration source resource identifier 604 a configuration target resource identifier based on the association stored in database 500.

FIG. 7 illustrates a target resource configuration 700 comprising fields for a target resource identifier 702, a configuration target resource identifier 704 and a label 706. The processor 322 generates the target resource configuration 700 based on the determined configuration target resource identifiers. The processor. 322 then sends the target resource configuration 700 to the target cloud 312 as a request to configure the target resource 314, such that the newly created storage volumes 317 and 318 get attached to the newly created target resource 314.

In one example, a wide range of virtual machine images are available for creating computing instances, such as a Ubuntu image with the identifier “ami-9f7a20da”. A machine image is an image of a storage volume that contains an entire operating system and application software. Machine images may be specific to what the purpose of the instance will be. For example, there may be provided machine images for web-servers or machine images for remote desktop applications. Each machine image comprises a kernel, such as a linux-3.6.1 kernel with the identifier “aki-4feec43b”, and multiple images for the same application may comprise different kernels. A kernel is a software layer that comprises basic drivers for hardware devices and provides system functions to applications, such as a web server application.

Because a machine image cannot be changed without shutting down the instance, the image needs to be specified before the instance is created, that is an image name needs to be included into the request to create a target instance. The processor 223 determines the image which is to be used to run the target resource. The processor 223 may select one image from a list of multiple images. Those images may be provided by official suppliers, by independent companies, or by individuals, such as RedHat or Fedora and each kernel provider may be associated with a reliability measure.

The reliability measure is determined based on the provider of the image. For example, virtual machines provided by Amazon, Microsoft, Redhat or Canonical yield higher scores. Processor 223 maintains in data memory 326 a list of known official virtual machine image publishers and their publisher ids. Another example is that if the name of a virtual machine contains strings such as “test” or “beta”, it yields lower score.

The processor 223 determines the name of the kernel of the source instance 304 and then determines a list of images in the target cloud 312 that comprise the same kernel.

Next, the processor 223 selects top-N (e.g., N=200) of the determined list of virtual machine images in the order of the reliability score. For each virtual machine in the top-N list, the processor 223 finds a virtual machine image in the target cloud 312 that has the same name as the one in the source cloud 302. The size of the list of virtual machines found in the target cloud 312 could be smaller than N since not all virtual machines in the source cloud 302 have a corresponding virtual machine in the target cloud 312.

The processor 223 sorts the list of virtual machines found in the target cloud 312 in the order of the reliability score and selects top M (M<=N, e.g., M=10) of virtual machines in the target cloud 312, which may use the same kernel. The processor 322 then tries the images one by one.

The Following Example is Provided:

1. Assume I have an virtual machine (instance) in the AWS Ireland datacenter launched from my own machine image X. X's kernel id is aki-4feec43b. (this is actually available in AWS.) To replicate my instance from Ireland to North California datacenter, I need to find an image in NCalifornia which is compatible with X. Of course there is no X in N California since that's what I've created in Ireland. Kernel id is the most useful information to find a compatible image but there is no image in N California using aki-4feec43c since it's a unique id only available in Ireland. (Same kernel has a different id in N California.)

2. Find all public and own images in Ireland using the kernel aki-4feec43b. Sort them in their reliability. For example “Score 13:

099720109477/ubuntu/images/ebs/ubuntu-maverick-10.10-amd64-server-20120310” means that the image

“099720109477/ubuntu/images/ebs/ubuntu-maverick-10.10-amd64-server-20120310” (099720109477 is id of the publisher) yields score 13.

3. On this particular example, we found about 350 images at the previous step. So, pick the top 180 images (this “180” is due to a limitation of AWS but we can use the whole list if we prefer) and find images in NCalifornia with the same name. It got 65 hits.

4. when we replicate an instance from Ireland to NCalifornia, we need to launch an instance at NCalifornia which is compatible with the one in Ireland. So, we try from the top of the 65 images.

In one example, source resource 306 is a firewall configured to manage first and second source security groups with identifiers “sg-b86e59ea” and “sg-a8d0e4fa”. Similar to selecting an image, an instance can only be added to a security group at the time the instance is being created. Therefore, the step of creating a resource in the target cloud also comprises determining a security group to which the new target resource needs to be assigned. For example, instance 304 with identifier “i-d21fa486” belongs to the first source security group “sg-b86e59ea”. A firewall is running in the target cloud 312 with first and second target security groups “sg-13626c56” and “sg-9ac097ff” and an association is stored between these identifiers of the target cloud 312 and the corresponding identifiers of the source cloud 302.

Processor 322 determines based on the associations stored in database 500, that is, processor 322 queries database 500, that instance 314 “i-6a28a52c” is to be attached to first target security group “sg-13626c56” if the first target security group “sg-13626c56” is associated with the first source security group “sg-b86e59ea”. The processor 322 then sends a request to the target cloud 312 to associate the created target resource 304 to the determined security group. This request may also be included into a request to create the resource 304. It is noted here that a particular instance can be attached to more than one security group or security groups may be dependent on each other. For example, second source security group “ sg-a8d0e4fa” allows traffic that has passed through the first source security group “sg-b86e59ea”.

Since the associations between source security groups and target security groups is required in order to create computing instances in the target cloud, the order in which the resources are created is important. Further, storage volumes with system images and application software are required to boot an instance when creating an instance.

In one example, the resources are created in the target cloud in a particular sequence, such that it can be guaranteed that a first resource that requires a second resources is not created before that second resource is created. The sequence, that is, the order, in which the resources are created may be based on the type of the resources. In the example of FIG. 3, the firewall would be the first type of resource to be created and the security groups are created in the order of dependency such that security groups which are dependent on other security groups are created later. This is followed by the storage volumes 307 to 309 and finally the computing instances 304 and 305.

In another example, processor 322 determines dependencies between resources, such as by analysing the source configurations 600 of all resources. If the identifier of a first resource is present in the configuration of a second resource, then the second resource depends on the first resource and processor 322 creates the first resource before the second resource.

One convenient way of storing dependencies on data store 326 is a directed graph where each node represents a resource and a directed edge from a second resource to a first resource represents a dependency of the second resource on the first resource. The second resource is referred to as predecessor of the first resource and the first resource is referred to as successor of the second resource. After creating the entire graph including all source resources, the processor 322 determines nodes that have no successor and creates a replica in the target cloud for each of these nodes. The processor 322 then traverses the graph in a breadth first manner and creates a resource in the target cloud for each node of the graph in the order as they are encountered. The order of creating the resources may also be based on knowledge of cloud providers. Some resources may not have identical equivalents in the target cloud and therefore, the dependencies may be different. A dedicated firewall instance, for example, as explained later, may not need to be created first although security groups, equivalent to the firewall instance in the source cloud, may need to be created before instances due to a restriction of the source cloud.

In one example, processor 322 replicates a system from Amazon Virginia to Tokyo datacenter.

1. Upon each replication run, our algorithm first scans all resources in Virginia datacenter and obtain the following information. It is stored as

Each instance's resource id, resource size (e.g., CPU amount), name, etc

Each security group's resource id and firewall configuration

Each disk volume's resource id, resource size (e.g., disk size), name, etc

Relationships among instances and security groups. e.g., SG1 is attached to I1, I2 and I3.

Relationships among instances and disk volumes. e.g., V3 is attached to I3 as the C: drive and V3-1 is attached to I3 as the D: drive.

2. Replicate volumes from Virginia to Tokyo. Each replication run creates a new replica volume in Tokyo and they have different resource id. The method as described earlier keeps the mapping from the original volume to a new volume. e.g., V1′ in Tokyo is the most recent replica of V1 in Virginia.

Failover (restore) the system in Tokyo datacenter

1. The processor 322 maintains a database with information about security groups which need to be defined before launching instances. Therefore, processor 322 first creates security groups.

2. The processor 322 creates security groups in Tokyo datacenter corresponding to SG1 and SG2. Say SG1′ and SG2′. The processor 322 keeps the mapping between the original and a replica, e.g., SG1 and SG1′. If there are dependencies among security groups, processor 322 creates from ones with no dependency.

3. Processor 322 launches instances with types being the same as those of I1, I2 and I3. To determine the type of instances to launch, processor 322 uses the information obtained when scanning the Virginia datacenter.

Some information is readily available such as size (CPU amount) of an instance. The same size can be selected in Tokyo since it's available across Amazon datacenters.

Some information is not so readily available. For example, processor 322 needs to pick a right operating system kernel to use when launching an Linux instance. (User's disk volume usually does not contain the kernel and it must be supplied by Amazon.) There are over 20 kernels available in each datacenter and they have random ids assigned by Amazon. Assume I1 uses kernel with id ‘X’ in Virginia. The processor 322 needs to pick a corresponding kernel to launch I1′ in Tokyo; however, a kernel with id ‘X’ does not exist in Tokyo since ids are randomly assigned. Even if it exists, there is no guarantee that the kernel ‘X’ in Tokyo is exactly same as the kernel ‘X’ in Virginia. Processor 322 can determine a corresponding kernels across datacenters as explained earlier.

4. Thanks to the mapping information from SG1 to SG1′ stored above, processor 322 can specify SG1′ to attach when launching a replica instance of I1. Say, I1′, I2′ and I3′.

5. The new instances I1′, I2′ and I3′ are in “clean” state, i.e., no application or data are stored there yet. Therefore, processor 322 first stops them, swap their disk volumes with replica disk volumes created before, attach extra replica disks if necessary, and restart the instances. For example, processor 322 stores an association that indicates that I1′ is a replica of I1. Processor 322 also knows that I1 had V1 as its C: drive and the most recent replica of V1 is V1′. From those information, processor 322 determines that V1′ should be attached to I1′ as the C: drive in the Tokyo datacenter.

6. Assume DNS names of those new instances are 111.ap-northeast-1.amazon.com, 222.ap-northeast-1.amazon.com, and 333.ap-northeast-1.amazon.com. The names and IP addresses are randomly assigned and there is no way to find the relations between the DNS names in Virginia and the new names in Tokyo. Since processor 322 stores the associations between instances, e.g., I1 and and it allows to tweak the network traffic among replica instances. For example, when I1′ sends a packet to 222.us-east-1.amazon.com (, which is the DNS name of I2), the packet is automatically re-routed to 222.ap-northeast-1.amazon.com (, which is the DNS name of I2′). When I2′ receives a packet from 111.ap-northeast-1.amazon.com (, which is the DNS name of I1′), the source address of the packet is rewritten to 111.us-east-1.amazon.com (,which is the DSN name of I1). This way, our algorithm makes applications running inside of I1′, I2′, or I3′ “believe” that they are still running in the original instance I1, I2 or I3. This way, the IP addresses are considered as identifiers and the processor 322 determines configuration target resource identifiers and sends a request to configure the target resource based on the determined target resource identifiers, that is, the determined IP addresses in the target cloud 312. The request may be a request to translate between the IP address of the target resource and the IP address of the source resource such that applications in the target cloud are running the same as in the source cloud as explained above.

The above description is in relation a homogenous cloud environment, which means that the source cloud 302 and the target cloud 312 are provided by the same cloud provider. As a result, source API 303 and target API 313 are very similar or even identical and available resources may also be similar or identical.

It is noted however, that the present invention may also be applied in a heterogeneous cloud environment, where APIs and available resources differ between the source cloud 302 and the target cloud 312. The format of the resource identifiers may also be vastly different between the source cloud 302 and the target cloud 312 but this difference does not affect the way the replication is performed as described earlier.

The difference is that in the case of a heterogeneous environment, the processor 322 determines how to emulate resources from the source cloud 302 which are not available in the target cloud 312. For example, non-AWS providers often have no security group. But security groups can be emulated by other methods such as by configuring each virtual machine to run a firewall inside that virtual machine or by creating a dedicated virtual machine, such as instance 316 in FIG. 3, as a firewall for all the other resources in the target cloud 312.

For each pair of source and destination cloud providers, e.g., AWS to Rackspace, AWS to GoGrid or Rackspace to GoGrid, the processor 322 maintains in datastore 326 an association to determine how to replicate or emulate resources. The processor 322 then uses this association in step 404 of FIG. 4 to create a request to create a target resource in the target cloud.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A method for creating a resource in a target cloud, the method comprising:
receiving or accessing a source resource identifier of a source resource in a source cloud;
sending a request to create a target resource in the target cloud;
receiving or accessing a target resource identifier of the created target resource; and
storing an association between the target resource identifier and the source resource identifier.

2. The method of claim 1, wherein the source cloud is located remotely from the target cloud.

3. The method of claim 1, wherein the method is repeated for two or more source resources such that two or more associations between target resource identifiers and source resource identifiers are stored.

4. The method of claim 3, wherein the method is repeated for two or more source resources in a sequence based on the type of the source resources.

5. The method of claim 3, wherein the method comprises determining a dependency between the two or more source resources and wherein the method is repeated for two or more source resources in a sequence based on the dependency between the two or more source resources.

6. The method of claim 5, wherein determining the dependency is based on configurations of the two or more source resources.

7. The method of claim 1 further comprising:
receiving or accessing a source configuration of the source resource, the source configuration comprising one or more configuration source resource identifiers;
determining for each configuration source resource identifier a configuration target resource identifier based on the stored association; and
sending a request to configure the target resource based on the determined configuration target resource identifiers.

8. The method of claim 1, wherein the target resource is a computing instance.

9. The method of claim 8, further comprising the step of determining an image for the target resource.

10. The method of claim 9, wherein determining the image comprises selecting one of multiple images.

11. The method of claim 10, wherein each of the multiple images is associated with an image provider and selecting one of multiple images is based on a reliability measure of each image provider.

12. The method of claim 1, wherein sending a request to create the target resource comprises:
determining a target security group based on previously stored target security groups; and
sending to the target cloud a request to associate the created target resource with the determined target security group.

13. A non-transitory computer readable medium with an executable program stored thereon that when executed causes a computer to perform the method of claim 1.

14. A computer system for creating a resource in a target cloud, the computer system comprising:
a data port to receive or access a source resource identifier of a source resource in a source cloud, to send a request to create a target resource in the target cloud, and to receive or access a target resource identifier of the created target resource; and
a processor to store in a data store an association between the target resource identifier and the source resource identifier.

15. A computer-implemented method for configuring a target resource in a target cloud, wherein one or more associations between one or more target resource identifiers and one or more source resource identifiers are stored in a data store, the method comprising:
receiving or accessing a source configuration of a source resource, the source configuration comprising one or more configuration source resource identifiers;
determining for each configuration source resource identifier a configuration target resource identifier based on the one or more stored associations; and
sending a request to configure the target resource based on the determined configuration target resource identifiers.

16. The method of claim 15, wherein the one or more associations are stored in a sequence based on the type of the target resources.

17. The method of claim 15, wherein the one or more associations are stored in a sequence based on a dependency between source resources associated with the one or more source resource identifiers.

18. The method of claim 15, wherein the determined configuration target resource identifier is an identifier of a storage volume in the target cloud and sending a request to configure the target resource comprises sending a request to attach the storage volume in the target cloud to the target resource.

19. The method of claim 15, wherein the configuration source resource identifiers and the configuration target resource identifiers are IP addresses.

20. The method of claim 19, wherein sending the request to configure the target resource comprises sending a request to translate between the IP address of the target resource and the IP address of the source resource.

21. A non-transitory computer readable medium with an executable program stored thereon that when executed causes a computer to perform the method of claim 15.

22. A computer system for configuring a target resource in a target cloud, the system comprising:
a processor to store in a data store one or more associations between one or more target resource identifiers and one or more source resource identifiers;
a data port to receive a source configuration of a source resource, the source configuration comprising one or more configuration source resource identifiers;
a processor to determine for each configuration source resource identifier a configuration target resource identifier based on the one or more stored associations; and
a data port to send a request to configure the target resource based on the determined configuration target resource identifiers.

23. A computer-implemented method for determining a target resource identifier of a target resource in a target cloud, the method comprising:
receiving or accessing a source resource identifier;
receiving or accessing one or more associations between one or more target resource identifiers and one or more source resource identifiers; and
determining a target resource identifier based on the source resource identifier and the one or more associations.

24. A non-transitory computer readable medium with an executable program stored thereon that when executed causes a computer to perform the method of claim 23.

25. A computer-system for determining a target resource identifier of a target resource in a target cloud, the computer system comprising:
a data port to receive or access a source resource identifier;
a data store to store one or more associations between one or more target resource identifiers and one or more source resource identifiers; and
a processor to determine a target resource identifier based on the source resource identifier and the one or more associations and to store the target resource identifier in a data store.
